(19) United States
(12) Patent Application Publication
(10) Pub. No.: US 2022/0074027 A1
(43) Pub. Date: Mar. 10, 2022

(54) HIGH-HARDNESS COMPOSITE OXIDE DISPERSION-STRENGTHENED TUNGSTEN ALLOY AND PREPARATION METHOD THEREOF

(71) Applicant: Hefei University of Technology, Hefei City (CN)

(72) Inventors: Laima LUO, Hefei City (CN); Zhihao Zhao, Hefei City (CN); Yucheng Wu, Hefei City (CN); Gang Yao, Hefei City (CN); Xiang Zan, Hefei City (CN); Xiaoyong Zhu, Hefei City (CN)

(73) Assignee: Hefei University of Technology, Hefei City (CN)

(21) Appl. No.: 17/374,442

(22) Filed: Jul. 13, 2021

(30) Foreign Application Priority Data
Sep. 4, 2020 (CN) 202010919137.2

(51) Int. Cl. C22C 27/04; C22C 1/05

(52) U.S. Cl. CPC C22C 27/04; C22C 1/058

(57) ABSTRACT

A high-hardness composite oxide dispersion-strengthened tungsten alloy and a preparation method thereof are disclosed. The high-hardness composite oxide dispersion-strengthened tungsten alloy consists essentially of a tungsten phase, and nano-scale Y₂O₃ and ZrO₂ particles dispersed in the tungsten phase, wherein there is a Y—Zr—O ternary phase structure at a coherent/semi-coherent interface.

### CROSS REFERENCE TO RELATED APPLICATION

This application claims the priority of Chinese Patent Application No. 202010919137.2, entitled “high-hardness composite oxide dispersion-strengthened tungsten alloy and preparation method thereof” filed with the Chinese National Intellectual Property Administration on Sep. 4, 2020, which is incorporated herein by reference in its entirety.

### TECHNICAL FIELD

The present disclosure relates to the technical field of metal structure materials, and particularly to a high-hardness composite oxide dispersion-strengthened tungsten alloy and a preparation method thereof.

### BACKGROUND

With the development of society, fossil energy as a non-renewable and unclean energy source will eventually face a crisis of exhaustion. However, fusion reactors, which are analogous to the source of solar energy, would make it possible to obtain sustainable clean energy by relying on tritium and deuterium fusion reactions. Plasma facing materials (PFMs), as the protective “armor” of fusion reactors, will directly face the huge energy from fusion reactions, which becomes one of the main problems that limit the practical application of fusion reactions.

Tungsten (W) has become a main candidate material for PFMs due to its high melting point (3410° C.), high thermal conductivity (174 W/(mk)), high sputtering threshold, low hydrogen isotope retention, resistance to neutron damage, and low activation. However, W has a higher ductile-brittle transition temperature (DBTT>400° C.) and a lower recrystallization temperature (RCT of about 1200° C.), which will cause radiation damage (swelling, hardening, amorphization, etc.), recrystallization embrittlement, high thermal load cracking and melting and other serious damages under the service conditions of the fusion reactor, thereby leading to serious degradation of material properties.

Studies have shown that a new type of W-based composite material with superior performance could be obtained by doping second phase oxide(s) or carbide(s), for example, by adding nano-scale Y₂O₃ and ZrO₂ particles into the tungsten matrix. Y₂O₃ and ZrO₂ have higher melting points and hardness than other oxides, and the melting point of ZrO₂ is as high as 2715° C. Such composite doping causes less loss of melting point and hardness of pure tungsten. Moreover, the doping of Y₂O₃ and ZrO₂ could effectively pin the movements of dislocations and grain boundaries, which is conducive to refining the grains and improving the strength and hardness of the material. Moreover, it is easy to form a Y—Zr—O ternary phase structure in the tungsten matrix, and the mechanical properties and the resistance to radiation damage could be further improved by adjusting the interface.

The oxide dispersion-strengthened (ODS) tungsten alloy composite powder is generally prepared by two types of methods: chemical method and mechanically alloying method. For the purpose of batch industrial production, chemical method has a wide range of application prospects. Among them, the wet chemical method has great advantages in the preparation of ODS tungsten alloy precursor powder, which is mainly reflected in the mild preparation conditions, simply available raw material, low production cost, high powder production efficiency, high powder quality, etc. The improved wet chemical method and the addition of the dispersant triethanolamine could effectively improve the distribution of the second phase oxides in the matrix, and significantly improve the performance of the sintered body.

### SUMMARY

An object of the present disclosure is to provide a high-hardness composite oxide dispersion-strengthened tungsten alloy and a preparation method thereof. By adding a small amount of nano-scale composite oxide particles, the tungsten grains are refined, the porosity is reduced, and the hardness of the obtained tungsten alloy is significantly improved compared with that of pure tungsten.

The present disclosure provides a high-hardness composite oxide dispersion-strengthened tungsten alloy, consisting essentially of, by mass 0.25% of Y₂O₃, 0.1% of ZrO₂, and a balance of tungsten. In such high-hardness composite oxide dispersion-strengthened tungsten alloy, there is a Y—Zr—O ternary phase structure at a coherent/semi-coherent interface, which effectively improves the interface strength, and achieves a high-hardness tungsten alloy with a low doping amount.

The present disclosure also provides a method for preparing the high-hardness composite oxide dispersion-strengthened tungsten alloy, comprising
preparation of a composite powder

calculating a mass ratio of reaction raw materials by converting the mass percentages of alloy components in the alloy composition, and preparing a precursor powder by a wet chemical method, in which nitrate containing Y³⁺ and Zr⁴⁺ is added to the ammonium metatungstate solution; dissolving yttrium nitrate (Y(NO₃)₃.6H₂O, from Aladdin, with a purity of not less than 99.9%), zirconium nitrate (Zr(NO₃)₄.5H₂O, from Aladdin), and surfactant triethanolamine (C₁₆H₂₂N₄O₃, with a purity of not less than 99%), in an appropriate amount of deionized water respectively, and stirring to be dispersed uniformly respectively, to obtain an aqueous yttrium nitrate solution, an aqueous zirconium nitrate solution, and an aqueous triethanolamine solution respectively; mixing the aqueous yttrium nitrate solution, the aqueous zirconium nitrate solution, and the aqueous triethanolamine solution, to obtain a mixed solution; heating while stirring the mixed solution to 100° C., pouring a solution of ammonium metatungstate (AMT, from Aladdin, with a purity of 99.95%) dissolved in an appropriate amount of deionized water thereto, and continuing heating while stirring until that the resulting mixture becomes transparent; finally adding a solution of an appropriate amount of oxalic acid (C₂H₂O₄, analytically pure) thereto, stirring the resulting solution at 140° C. until that the solution is completely volatilized, to obtain a precipitated block, i.e. a precursor; drying the precursor, and grinding the dried precursor, to obtain a precursor powder; and reducing the precursor powder in a hydrogen atmosphere, to obtain a W—Y₂O₃—ZrO₂ composite powder;
sintering of the W—Y₂O₃—ZrO₂ composite powder

loading the W—Y₂O₃—ZrO₂ composite powder into a graphite mold and compacting, putting the loaded graphite mold into a spark plasma sintering furnace, applying a pre-pressure to the W—Y₂O₃—ZrO₂ composite powder, vacuuming the spark plasma sintering furnace, and subjecting the W—Y₂O₃—ZrO₂ composite powder to a two-stage heat-preservation sintering; and cooling the sintered W—Y₂O₃—ZrO₂ composite powder in the spark plasma sintering furnace to room temperature, to obtain a block of the W—Y₂O₃—ZrO₂ alloy.

In some embodiments, reducing the precursor powder in a hydrogen atmosphere comprises subjecting the precursor powder to a two-stage pyrolysis, which comprises

first heating the precursor powder to 500-600° C., and maintaining at the temperature for 60-80 minutes, and

further heating to 800-900° C., and maintaining at the temperature for 100-120 minutes.

In some embodiments, the two-stage heat-preservation sintering comprises

a first stage heat-preservation sintering, which is performed at 750-850° C. for 5-10 minutes; and

a second stage heat-preservation sintering, which is performed at 1500-1600° C. for 1-3 minutes.

In some embodiments, before the first stage heat-preservation sintering, the pre-pressure is not more than 14 MPa, and when the first stage heat-preservation sintering starts, the pre-pressure starts increasing, and after the first stage heat-preservation sintering, the pre-pressure increases up to 50-100 MPa at a constant rate. In some embodiments, during the second stage heat-preservation sintering, the pre-pressure is constant.

The ODS tungsten alloy according to the present disclosure is prepared by adding nano-scale Y₂O₃ and ZrO₂ particles simultaneously, and reducing them, to obtain a fine and uniform composite powder after reducing, and sintering the composite powder. During the sintering, nano-scale Y₂O₃ and ZrO₂ particles have a pinning effect on the grain boundaries movement, thereby significantly refining grains, and significantly improving the interface strength through the adjustment of the Y—Zr—O coherent/semi-coherent interface, so as to obtain a high-hardness W—Y₂O₃—ZrO₂ alloy with a low doping amount.

The present disclosure has the following advantages:

1. By doping second phase oxides in an amount of not more than 0.35% by mass, the relative density of the tungsten alloy according to the present disclosure is increased to 98% compared with that of pure tungsten, and meanwhile the hardness thereof reaches 703Hv_{0.2}. Herein, the hardness is measured according to GBT4342-1991.

2. According to the present disclosure, a wet chemical method is used to prepare the W—Y₂O₃—ZrO₂ precursor powder, which is low in preparation cost, and could be used for industrial batch preparation.

3. The W—Y₂O₃—ZrO₂ alloy prepared by the method according to the present disclosure has important development prospects. By constructing a Y—Zr—O coherent/semi-coherent interface, not only the mechanical properties of the alloy could be significantly improved compared with those of pure tungsten, but the additional interface introduced by Y₂O₃ and ZrO₂ particles is of great significance in improving the performance of resisting plasma radiation damage.

### Definition

The term “relative density” refers to the ratio of actual density to theoretical density.

### BRIEF DESCRIPTION OF THE DRAWINGS

FIG. 1 shows a scanning electron microscope image of W—Y₂O₃—ZrO₂ composite powder after reducing. It can be seen from FIG. 1 that among the W—Y₂O₃—ZrO₂ composite precursor powder prepared by the method according to the present disclosure, larger particles have a particle size of about 200 nm, and smaller particles have a particle size of about 50 nm. The increase in the surface area of the powder is conducive to improving the sintering activity.

FIG. 2 shows a scanning electron microscope image of the fracture surface of the W—Y₂O₃—ZrO₂ composite material. It can be seen from FIG. 2 that the grains have a size of about 1.5 μm, and that there are many fine particles and pits after pulling out, indicating that the finely dispersed second phase is evenly distributed in the tungsten matrix. In the present disclosure, the size of the grain (namely grain size) is measured according to GBT6394-2017.

FIG. 3 shows a transmission electron microscope image of a block of tungsten-based composite material after sintering. It can be seen from FIG. 3 that second-phase particles on the grain boundaries have a larger particle size of about 200 nm, while intracrystalline second-phase particles have a smaller particle size of about 50 nm.

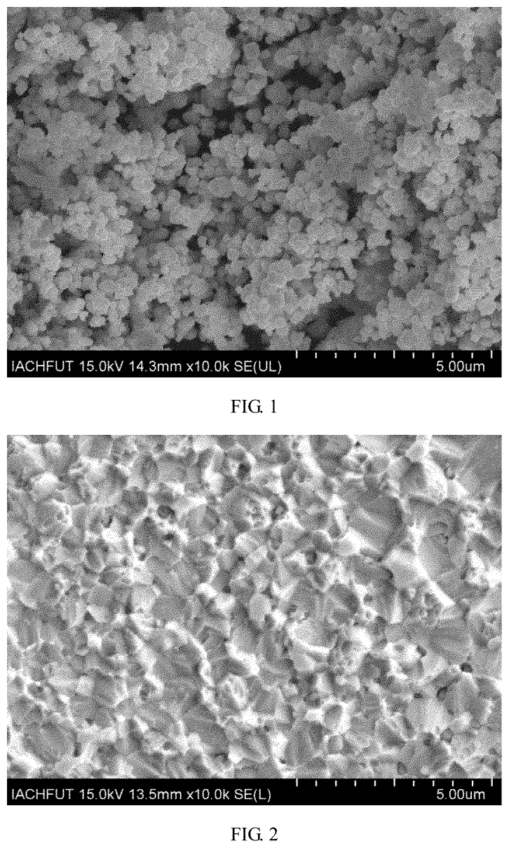

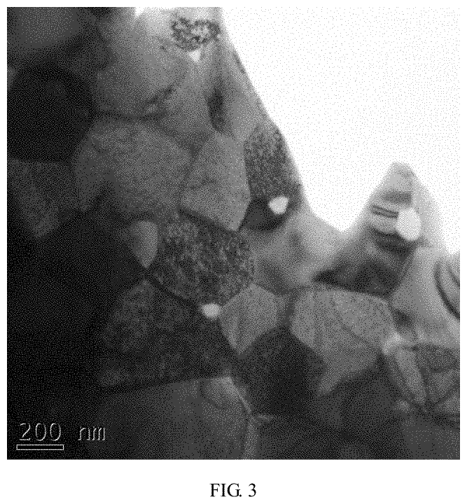

### DETAILED DESCRIPTION OF THE EMBODIMENTS

### Example 1

In this example, the composite oxide dispersion-strengthened tungsten alloy was prepared according to the following procedure:

Step 1, Preparation of a Composite Powder

The mass ratio of reaction raw materials was calculated by converting the mass percentages of alloy components in the alloy composition, and a precursor powder was prepared by a wet chemical method, in which nitrate(s) containing Y³⁺ and Zr⁴⁺ was added to the ammonium metatungstate solution. Yttrium nitrate (Y(NO₃)₃.6H₂O, from Aladdin, with a purity of not less than 99.9%), zirconium nitrate (Zr(NO₃)₄.5H₂O, from Aladdin), and surfactant triethanolamine (C₁₆H₂₂N₄O₃, with a purity of not less than 99%) were dissolved in an appropriate amount of deionized water respectively, and they were stirred for a period of time respectively, obtaining an aqueous yttrium nitrate solution, an aqueous zirconium nitrate solution, and an aqueous triethanolamine solution respectively. The three kinds of solutions were mixed, obtaining a mixed solution. The mixed solution was heated while stirring to 100° C., and a solution of ammonium metatungstate (AMT, from Aladdin, with a purity of 99.95%) dissolved in an appropriate amount of deionized water was poured thereto, and the heating was continued while stirring until that the resulting mixture becomes transparent. Finally a solution with an appropriate amount of oxalic acid (C₂H₂O₄, analytically pure) was added thereto, and the resulting solution was stirred at 140° C. until that the solution was completely volatilized, obtaining a precipitated block, i.e. a precursor. The precursor was dried, and the dried precursor was ground, obtaining a precursor powder. The precursor powder was reduced in a hydrogen atmosphere, obtaining a composite powder of W—Y₂O₃—ZrO₂, in which the precursor powder was poured uniformly into a combustion boat, and the combustion boat was placed in a tube furnace, and the precursor powder was reduced by a two-stage pyrolysis in a hydrogen atmosphere with a hydrogen purity greater than or equal to 99.999%.

In this step, yttrium nitrate, zirconium nitrate, triethanolamine, and oxalic acid were added in an amount of 0.6%, 0.3%, 6%, and 38.5%, respectively, based on the mass of ammonium metatungstate; and

the process that the precursor powder was reduced in a hydrogen atmosphere was performed by a two-stage pyrolysis, i.e. first heating to 600° C., and maintaining at the temperature for 60 minutes; and further heating to 800° C., and maintaining at the temperature for 120 minutes.

Step 2, Sintering of the W—Y₂O₃—ZrO₂ composite powder

The W—Y₂O₃—ZrO₂ composite powder prepared in step 1 was loaded into a graphite mold and compacted. The loaded graphite mold was put into a spark plasma sintering furnace. A pre-pressure was applied to the W—Y₂O₃—ZrO₂ composite powder. Then the spark plasma sintering furnace was vacuumed, and the W—Y₂O₃—ZrO₂ composite powder was subjected to a two-stage heat-preservation sintering. After starting the sintering, the W—Y₂O₃—ZrO₂ composite powder was heated to 800° C., and maintained at the temperature for 5 minutes; then the W—Y₂O₃—ZrO₂ composite powder was heated to 1600° C., and maintained at the temperature for 60 seconds. The sintered W—Y₂O₃—ZrO₂ composite powder was cooled in the spark plasma sintering furnace to ambient temperature, obtaining a block of the W—Y₂O₃—ZrO₂ alloy. In this step, the pre-pressure was 14 MPa when the temperature was not higher than 800° C., and increased to 75 MPa at a constant rate during the process of maintaining at 800° C. for 5 minutes; the block obtained after cooling was a W—Y₂O₃—ZrO₂ alloy with a grain size of 1.5 μm, a relative density of 98.7%, and a hardness of 703Hv_{0.2}.

### Example 2

In this example, the composite oxide dispersion-strengthened tungsten alloy was prepared according to the following procedure:

Step 1, Preparation of a Composite Powder

The mass ratio of reaction raw materials was calculated by converting the mass percentages of alloy components in the alloy composition, and a precursor powder was prepared by a wet chemical method, in which nitrate(s) containing Y³⁺ and Zr⁴⁺ was added to the ammonium metatungstate solution. Yttrium nitrate (Y(NO₃)₃.6H₂O, from Aladdin, with a purity of not less than 99.9%), zirconium nitrate (Zr(NO₃)₄.5H₂O, from Aladdin), and surfactant triethanolamine (C₁₆H₂₂N₄O₃, with a purity of not less than 99%) were dissolved in an appropriate amount of deionized water respectively, and they were stirred for a period of time respectively, obtaining an aqueous yttrium nitrate solution, an aqueous zirconium nitrate solution, and an aqueous triethanolamine solution respectively. Three kinds of solutions were mixed, obtaining a mixed solution. The mixed solution was heated while stirring to 100° C., and a solution of ammonium metatungstate (AMT, from Aladdin, with a purity of 99.95%) dissolved in an appropriate amount of deionized water was poured thereto, and the heating was continued while stirring until that the resulting mixture becomes transparent. Finally a solution with an appropriate amount of oxalic acid (C₂H₂O₄, analytically pure) was added thereto, and the resulting solution was stirred at 140° C. until that the solution was completely volatilized, obtaining a precipitated block, i.e. a precursor. The precursor was dried, and the dried precursor was ground, obtaining a precursor powder. The precursor powder was reduced in a hydrogen atmosphere, obtaining a composite powder of W—Y₂O₃—ZrO₂, in which the precursor powder was poured uniformly into a combustion boat, and the combustion boat was placed in a tube furnace, and the precursor powder was reduced by a two-stage pyrolysis in a hydrogen atmosphere with a hydrogen purity greater than or equal to 99.999%.

In this step, yttrium nitrate, zirconium nitrate, triethanolamine, and oxalic acid were added in an amount of 0.6%, 0.3%, 6%, and 38.5%, respectively, based on the mass of ammonium metatungstate; and

the reduction was performed by a two-stage pyrolysis, i.e. first heating to 550° C., and maintaining at the temperature for 70 minutes; and further heating to 850° C., and maintaining at the temperature for 110 minutes.

Step 2, sintering of the W—Y₂O₃—ZrO₂ composite powder

The W—Y₂O₃—ZrO₂ composite powder prepared in step 1 was loaded into a graphite mold and compacted. The loaded graphite mold was put into a spark plasma sintering furnace. A pre-pressure was applied to the W—Y₂O₃—ZrO₂ composite powder. Then the spark plasma sintering furnace was vacuumed, and the W—Y₂O₃—ZrO₂ composite powder was subjected to a two-stage heat-preservation sintering. After starting the sintering, the W—Y₂O₃—ZrO₂ composite powder was heated to 750° C., and maintained at the temperature for 10 minutes; then the W—Y₂O₃—ZrO₂ composite powder was heated to 1500° C., and maintained at the temperature for 3 minutes. The sintered W—Y₂O₃—ZrO₂ composite powder was cooled in the spark plasma sintering furnace to ambient temperature, obtaining a block of the W—Y₂O₃—ZrO₂ alloy. In this step, the pre-pressure was 14 MPa when the temperature was not higher than 750° C., and increased to 100 MPa at a constant rate during the process of maintaining at 750° C. for 10 minutes; the block obtained after cooling was a W—Y₂O₃—ZrO₂ alloy with a grain size of 2 μm, a relative density of 98.5%, and a hardness of 691Hv_{0.2}.

### Example 3

In this example, the composite oxide dispersion-strengthened tungsten alloy was prepared according to the following procedure:

Step 1, Preparation of a Composite Powder

The mass ratio of reaction raw materials was calculated by converting the mass percentages of alloy components in the alloy composition, and a precursor powder was prepared by a wet chemical method, in which nitrate(s) containing Y³⁺ and Zr⁴⁺ was added to the ammonium metatungstate solution. Yttrium nitrate (Y(NO₃)₃.6H₂O, from Aladdin, with a purity of not less than 99.9%), zirconium nitrate (Zr(NO₃)₄.5H₂O, from Aladdin), and surfactant triethanolamine (C₁₆H₂₂N₄O₃, with a purity of not less than 99%) were dissolved in an appropriate amount of deionized water respectively, and they were stirred for a period of time respectively, obtaining an aqueous yttrium nitrate solution, an aqueous zirconium nitrate solution, and an aqueous triethanolamine solution respectively. Three kinds of solutions were mixed, obtaining a mixed solution. The mixed solution was heated while stirring to 100° C., and a solution of ammonium metatungstate (AMT, from Aladdin, with a purity of 99.95%) dissolved in an appropriate amount of deionized water was poured thereto, and the heating was continued while stirring until that the resulting mixture becomes transparent. Finally a solution with an appropriate amount of oxalic acid (C₂H₂O₄, analytically pure) was added thereto, and the resulting solution was stirred at 140° C. until that the solution was completely volatilized, obtaining a precipitated block, i.e. a precursor. The precursor was dried, and the dried precursor was ground, obtaining a precursor powder. The precursor powder was reduced in a hydrogen atmosphere, obtaining a composite powder of W—Y₂O₃—ZrO₂, in which the precursor powder was poured uniformly into a combustion boat, and the combustion boat was placed in a tube furnace, and the precursor powder was reduced by a two-stage pyrolysis in a hydrogen atmosphere with a hydrogen purity greater than or equal to 99.999%.

In this step, yttrium nitrate, zirconium nitrate, triethanolamine, and oxalic acid were added in an amount of 0.6%, 0.3%, 6%, and 38.5%, respectively, based on the mass of ammonium metatungstate; and

the reduction was performed by a two-stage pyrolysis, i.e. first heating to 500° C., and maintaining at the temperature for 80 minutes; and further heating to 900° C., and maintaining at the temperature for 100 minutes.

Step 2, Sintering of the W—Y₂O₃—ZrO₂ composite powder

the W—Y₂O₃—ZrO₂ composite powder prepared in step 1 was loaded into a graphite mold and compacted. The loaded graphite mold was put into a spark plasma sintering furnace. A pre-pressure was applied to the W—Y₂O₃—ZrO₂ composite powder. Then the spark plasma sintering furnace was vacuumed, and the W—Y₂O₃—ZrO₂ composite powder was subjected to a two-stage heat-preservation sintering. After starting the sintering, the W—Y₂O₃—ZrO₂ composite powder was heated to 850° C., and maintained at the temperature for 8 minutes; then the W—Y₂O₃—ZrO₂ composite powder was heated to 1550° C., and maintained at the temperature for 2 minutes. The sintered W—Y₂O₃—ZrO₂ composite powder was cooled in the spark plasma sintering furnace to ambient temperature, obtaining a block of the W—Y₂O₃—ZrO₂ alloy. In this step, the pre-pressure was 14 MPa when the temperature was not higher than 850° C., and increased to 50 MPa at a constant rate during the process of maintaining at 850° C. for 8 minutes; the block obtained after cooling was a W—Y₂O₃—ZrO₂ alloy with a grain size of 2 μm, a relative density of 98.6%, and a hardness of 695Hv_{0.2}.

What is claimed is:

1. A high-hardness composite oxide dispersion-strengthened tungsten alloy, consisting essentially of a tungsten phase, and nano-scale Y₂O₃ and ZrO₂ particles dispersed in the tungsten phase, wherein there is a Y—Zr—O ternary phase structure at a coherent/semi-coherent interface in the high-hardness composite oxide dispersion-strengthened tungsten alloy.

2. The high-hardness composite oxide dispersion-strengthened tungsten alloy as claimed in claim 1, consisting essentially of 0.25% of Y₂O₃, 0.1% of ZrO₂, and a balance of tungsten.

3. A method for preparing the high-hardness composite oxide dispersion-strengthened tungsten alloy as claimed in claim 1, comprising
preparation of a composite powder
dissolving yttrium nitrate, zirconium nitrate, and surfactant triethanolamine, with a certain proportion, in an appropriate amount of deionized water respectively, and stirring to be dispersed uniformly respectively, to obtain an aqueous yttrium nitrate solution, an aqueous zirconium nitrate solution, and an aqueous triethanolamine solution respectively;
mixing the aqueous yttrium nitrate solution, the aqueous zirconium nitrate solution, and the aqueous triethanolamine solution, to obtain a mixed solution;
heating while stirring the mixed solution to 100° C., pouring a solution of ammonium metatungstate dissolved in deionized water thereto, and continuing heating while stirring until that the resulting mixture becomes transparent;
adding a solution of an appropriate amount of oxalic acid thereto, stirring the resulting solution at 140° C. until that the solution is completely volatilized, to obtain a precipitated block, i.e. a precursor;
drying the precursor, and grinding the dried precursor, to obtain a precursor powder; and
reducing the precursor powder in a hydrogen atmosphere, to obtain a W—Y₂O₃—ZrO₂ composite powder;
sintering of the W—Y₂O₃—ZrO₂ composite powder
loading the W—Y₂O₃—ZrO₂ composite powder into a graphite mold and compacting, putting the loaded graphite mold into a spark plasma sintering furnace, applying a pre-pressure to the W—Y₂O₃—ZrO₂ composite powder, vacuuming the spark plasma sintering furnace, and subjecting the W—Y₂O₃—ZrO₂ composite powder to a two-stage heat-preservation sintering; and cooling the sintered W—Y₂O₃—ZrO₂ composite powder in the spark plasma sintering furnace to ambient temperature, to obtain a block of the W—Y₂O₃—ZrO₂ alloy.

4. The method as claimed in claim 3, wherein reducing the precursor powder in a hydrogen atmosphere comprises subjecting the precursor powder to a two-stage pyrolysis, which comprises
first heating the precursor powder to 500-600° C., and maintaining at the temperature for 60-80 minutes, and
further heating to 800-900° C., and maintaining at the temperature for 100-120 minutes.

5. The method as claimed in claim 3, wherein the two-stage heat-preservation sintering comprises
a first stage heat-preservation sintering, which is performed at 750-850° C. for 5-10 minutes; and
a second stage heat-preservation sintering, which is performed at 1500-1600° C. for 1-3 minutes.

6. The method as claimed in claim 3, wherein before the first stage heat-preservation sintering, the pre-pressure is not more than 14 MPa, and when the first stage heat-preservation sintering starts, the pre-pressure starts increasing, and after the first stage heat-preservation sintering, the pre-pressure increases up to 50-100 MPa at a constant rate.

7. The method as claimed in claim 5, wherein before the first stage heat-preservation sintering, the pre-pressure is not more than 14 MPa, and when the first stage heat-preservation sintering starts, the pre-pressure starts increasing, and after the first stage heat-preservation sintering, the pre-pressure increases up to 50-100 MPa at a constant rate.
